(19) United States
(12) Patent Application Publication
(10) Pub. No.: US 2024/0382958 A1
(43) Pub. Date: Nov. 21, 2024

(54) SYSTEM AND METHOD FOR DIGITAL, MULTIPLEXED, EXTRACELLULAR VESICLE-DERIVED BIOMARKER DIAGNOSTIC LAB-ON-A-CHIP AND METHOD OF USE THEREOF

(71) Applicant: Bryan Joseph Rice, Hillsboro, OR (US)

(72) Inventor: Bryan Joseph Rice, Hillsboro, OR (US)

(21) Appl. No.: 18/667,784

(22) Filed: May 17, 2024

Related U.S. Application Data
(60) Provisional application No. 63/467,546, filed on May 18, 2023.

(51) Int. Cl. B01L 3/00; G01N 27/447

(52) U.S. Cl. CPC B01L 3/502753; B01L 3/502715; G01N 27/447; B01L 2300/0663; B01L 2300/0816; B01L 2300/1844; B01L 2400/0487; B01L 2400/06

(57) ABSTRACT

The present invention is directed to a system and method for digital, multiplexed, extracellular vesicle-derived biomarker diagnostic lab-on-a-chip and method of use thereof. The present invention provides a minimally invasive system and method for early disease detection using extracellular vesicles as biomarkers for disease. Extracellular vesicles are collected from a fluid biological sample and subjected to a sorting process which provide a purified liquid containing the biomarkers of interest.

### CROSS REFERENCE TO RELATED APPLICATIONS

This application claims the benefit of U.S. Provisional Patent Application Ser. No. 63/467,546 filed May 18, 2023, the contents of which are incorporated herein by reference.

### BACKGROUND OF THE INVENTION

The present invention is directed to a system and method for digital, multiplexed, extracellular vesicle-derived biomarker diagnostic lab-on-a-chip and method of use thereof. There is a growing demand for diagnostic markers for early disease detection, which increases the survivability odds of many diseases. Early disease detection requires sensitive diagnostic tools to detect low quantities of specific biomarkers which are indicative of disease. Currently, few methods exist which provide the sensitivity and specificity necessary to detect biomarkers for diseases such as cancer. Current methods including biopsy, computerized tomography, magnetic resonance imaging (“MRI”), endoscopy procedures, etc. are costly, invasive, and time intensive. The present invention provides a minimally invasive and accurate method for early diagnostics with lower costs than current methods previously described.

The present invention provides an approach to early diagnostics which relies on the detection of extracellular vesicles (“EVs”) which can be collected from biological fluids including blood, urine, cerebrospinal fluid, etc. EVs are membranous nanoparticles that facilitate intercellular communication via their biomolecular components such as proteins, lipids, carbohydrates, and nucleic acids. Furthermore, EVs are dense information compartments which are continuously released from originating cells which contain biomarkers that mimic those of their originating cells. EV-associated biomarkers can exhibit longer half-lives and increased stability than free circulating biomarkers, thus providing an accessible source of biomarkers that are continuously released from live cells within the body.

Liquid biopsy, a popular method of cancer detection, relies upon free circulating biomarkers released during tumor cell death, rather than a continuous and sustained cellular process such as EV secretion. EVs represent a valuable bio-compartment for early, minimally invasive detection for disease-associated biomarkers from their parent cells including tumor cells, neurons affected by neurodegeneration, inflammatory cells, etc.). Existing EV biomarker test methods rely on fluorescence-based detection, which is limited in sensitivity and specificity. The present invention explores alternatives to current detection methods which improve upon the state-of-the-art methods via effective biomarker concentration and sensitive, specific biomarker detection using electronic methods.

### SUMMARY OF THE INVENTION

The present invention pertains to a filter system comprising a cartridge unit capable of receiving at least one biological sample and processing the biological sample to isolate a desired biomarker from the biological sample and a device controlled by a suite of software capable receiving one or more cartridge units for the purpose of performing assays on one or more biological samples. The system of the present invention is designed to provide early disease detection and diagnosis using extracellular vesicles (“EVs”) as biomarkers found in biological fluids including blood, urine, cerebrospinal fluid, and other biological fluids which can be collected via minimally invasive methods.

The cartridge unit provided in the present invention consists of a plurality of parts capable of receiving a sample of biological fluid and a series of fluidic channels and valves which distribute the sample to a chip capable of performing an assay. In some embodiments, more than one sample may be received and distributed to more than one chip separately. A central rotary valve allows two samples and their respective reagents to flow across the cartridge unit separately. The fluidics channels may also operate as an immediate storage and/or waste system.

In some embodiments, the chip portions of the cartridge unit may be configured to perform dielectrophoresis (“DEP”) as a method for sorting the desired biomarkers within the biological sample placed in the cartridge. DEP is the translation of a polarized or dielectric particle in a non-uniform electric field. DEP provides a novel isolation technology that brings new capability which exploits the electrical and material properties of EVs to achieve label-free specific capture and high yield recovery. Unlike direct current (“DC”) electrophoresis, an electrode geometry which generates a strong electric field gradient induces a neutral but polarizable particle, such as exosomes, to have a force that concentrates these particles on the very tip of the electrode geometry. By using alternating current (“AC”) signal, any electrophoretic forces are effectively averaged out to zero while the DEP force remains, thus separating the desired biomarkers from other biological molecules in a complex mixture such as human plasma or conditioned media. Unlike other methods below, this isolation method is nonmechanical, label-free, and lends itself to automated operation and high throughput.

Furthermore, the present invention provides a user interface while allows remote computerized control of present invention via at least one computer system. A computer system may include one or more processors, memory, storage, input/output (“I/O”) interfaces, communication interfaces, and buses. Although this disclosure describes and illustrates a particular computer system having a particular number of particular components in a particular arrangement, this disclosure contemplates any suitable computer system having any suitable number of any suitable components in any suitable arrangement.

In particular embodiments, a processor includes hardware for executing computer-readable instructions, such as those making up a computer program. As an example, and not by way of limitation, to execute instructions, processor may retrieve (or fetch) the instructions from an internal register, an internal cache, memory, or storage; decode and execute them; and then write one or more results to an internal register, an internal cache, memory, or storage. In some embodiments, the instructions may pertain to activating and controlling a plurality of fluidics chambers, channels, rotors, valves and other parts described as being associated with a cartridge unit herein. More specifically, these instructions may pertain to moving a plurality of liquids throughout a cartridge unit disclosed herein via the plurality of fluidics chambers, channels, rotors, and valves for the purposes of separating desired biomarkers from a biological sample which may be used for diagnostic purposes.

In particular embodiments, processor may include one or more internal caches for data, instructions, or addresses. This disclosure contemplates processor including any suitable number of any suitable internal caches, where appropriate. As an example, and not by way of limitation, processor may include one or more instruction caches, one or more data caches, and one or more translation lookaside buffers (“TLBs”). Instructions in the instruction caches may be copies of instructions in memory or storage, and the instruction caches may speed up retrieval of those instructions by processor.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 illustrates example diagram of a top view of a cartridge concept.

FIG. 2 illustrates a reagent cartridge connected to one or more manifolds with one or more SMV valves.

FIG. 3 illustrates an example program flow diagram.

FIG. 4 illustrates an example program flow diagram for operating one or more rotary valves of a cartridge.

FIG. 5 illustrates an example computer system.

FIG. 6 illustrates an example hybrid program flow diagram.

FIGS. 7A-B illustrate example diagrams of a top-view of a cartridge concept.

FIGS. 8A-B illustrate example diagrams of a rotary valve in particular configurations.

FIGS. 9A-B illustrate example diagrams of rotary a rotary valve in particular configurations.

FIG. 10 illustrates an example diagram of a cartridge, containing one or more fluidics channels and parts.

FIG. 11 illustrates an example diagram of a cartridge, containing one or more fluidics channels and parts.

FIG. 12 illustrates an example diagram of a cartridge, containing one or more fluidics channels and parts.

FIGS. 13A-L illustrate various screens of a virtual portal.

FIG. 14 illustrates a summary of the process steps.

### DETAILED DESCRIPTION OF THE PREFERRED EMBODIMENT

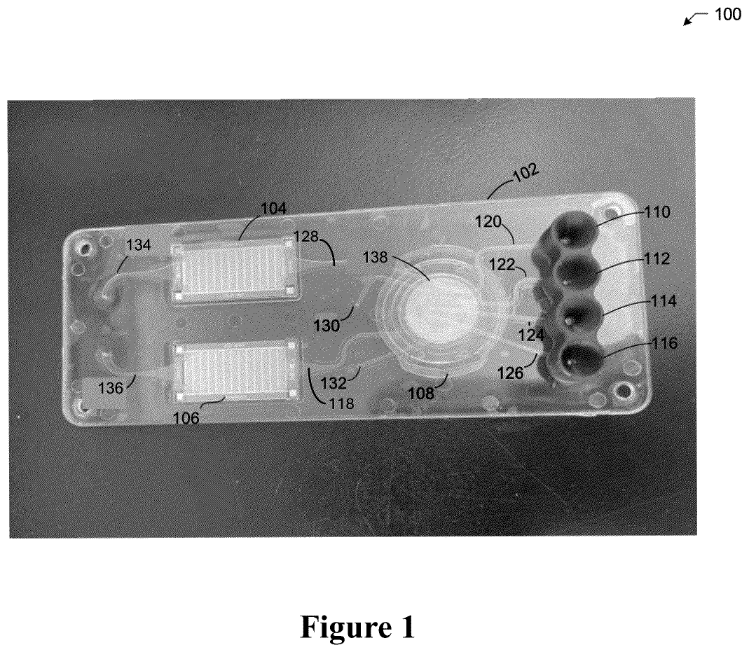

FIG. 1 illustrates example diagram of a top view of a cartridge 102 concept. In accordance with particular embodiments of the present invention, cartridge 102 may be injection molded. In particular embodiments, cartridge 102 may be constructed of polymethyl methacrylate (“PMMA”). Although this disclosure discusses that cartridge 102 may be constructed of PMMA, this disclosure contemplates any other suitable material. In particular embodiments, chip 104 may process a first sample, referred to herein as “Sample 1.” In particular embodiments, chip 106 may process a second sample, referred to herein as “Sample 2.” Sample 1 and Sample 2 may be biological fluids, for example, and not by way of limitation, Sample 1 and Sample 2 may be blood, urine, cerebrospinal fluid, or other biological fluid. The biological fluid may be a specific biological fluid which is known to contain extracellular vesicles (“EVs”) or other extracellular-derived biomarkers. Desired biomarkers may be collected for diagnosis of a disease.

In particular embodiments, Sample 1 may be input via part 110, wherein the first biological sample may be input to part 110 of cartridge 102, which may be a receptacle, via fluidics machinery, medical equipment (for example, and not by way of limitation, a syringe), and/or one or more mechanisms for accepting biological sample inputs. Although this disclosure discussed the aforementioned methods of inputting a biological sample into one or more dielectrophoresis (“DEP”) chambers of the filter system, this disclosure contemplates any suitable method of delivering one or more biological samples into cartridge 102. In some embodiments, chip 104 may receive Sample 1 for processing via fluidics channel 128. In particular embodiments, part 112 of cartridge 102 may output eluate from Sample 1.

In particular embodiments, Sample 2 may be input via part 114, wherein the first biological sample may be input to part 114 of cartridge 102 via fluidics machinery, medical equipment (for example, and not by way of limitation, a syringe), and/or one or more mechanisms for accepting biological sample inputs. Although this disclosure discussed the aforementioned methods of inputting a biological sample into one or more DEP chambers of the filter system, this disclosure contemplates any suitable method of delivering one or more biological samples into cartridge 102. In some embodiments, chip 106 may receive Sample 2 for processing via fluidics channel 118. In particular embodiments, part 116 of cartridge 102 may output eluate from Sample 2.

In particular embodiments, fluidics channels 120, 122, 124, 126 may carry one or more biological samples through the cartridge 102 to one or more chips 104, 106. As an example, and not by way of limitation, fluidics channels 120, 122, 124, 126 may move fluid (for example, biological samples, wash volume, etc.) between one or more components of cartridge 102. In particular embodiments, fluidics channels 120, 122, 124, 126 may operate as an immediate storage and/or waste system. As an example, and not by way of limitation, fluidics channels 120, 122, 124, 126 may be coated by one or more films, sealing the back of one or more injection molded parts of cartridge 102. As an example, and not by way of limitation, fluidics channels 120 and 124 may be the same length. As an example, and not by way of limitation, fluidics channels 122 and 126 may be the same length.

In particular embodiments, rotary valve 138 may be comprised of two or more pieces. As an example, and not by way of limitation, rotary valve 138 may be injection molded with an over molding of thermoplastic elastomers (“TPE”). In particular embodiments, rotary valve may be held in place by one or more acrylic pieces 108.

In particular embodiments, reagent-in fluidic line 130 may input reagent for Sample 1. In particular embodiments, reagent-in fluidic line 132 may input reagent for Sample 2. In particular embodiments, waste from Sample 1 may be output via waste fluidic 134. In particular embodiments, waste from Sample 2 may be output via waste fluidic 136.

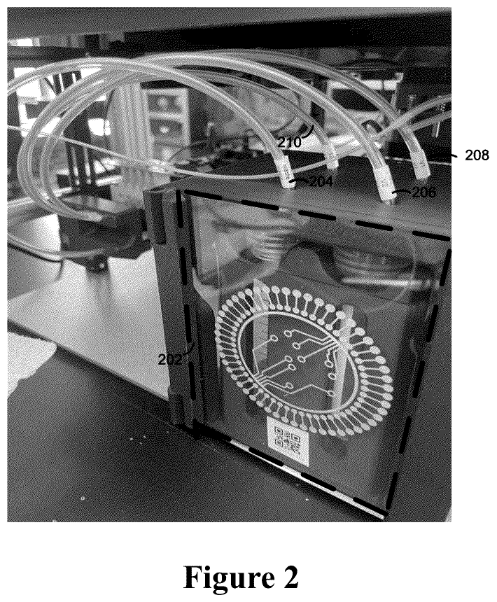

FIG. 2 illustrates a reagent cartridge connected to one or more manifolds with one or more SMV valves. In accordance with the preferred embodiment of the present invention, a reagent cartridge 202 is connected to one or more manifolds with one or more sampled measured value (“SMV”) valves 204, 206, 208 and 210 with automatic reloading mechanisms.

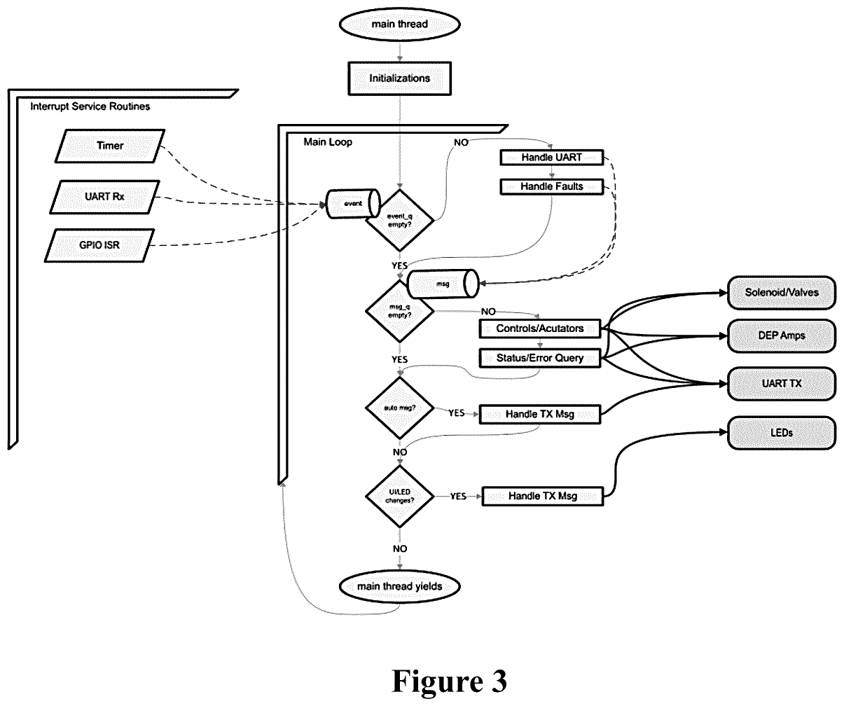

FIG. 3 illustrates an example program flow diagram of the software infrastructure of the present invention. In accordance with the preferred embodiment of the present invention, the main loop continually tests for input from main thread initialization and an interrupt service routine (“ISR”) which is in turn testing for interrupt input from a timer, a universal asynchronous receiver/transmitter (“UART”), and a general-purpose input/output (“GPIO”) ISR. In alternative embodiments, additional receivers, pins, timers, and other infrastructure may provide input to the ISR. The input received from the ISR via the main loop is received as an event. As event input is received, the main loop continuously tests if the even input is empty. Negative input signals (i.e., following the “NO” pathway) are handled via a fault handler or similar structure which processes the fault data and transforms it into the correct format to be sent downstream as a message (“msg”). If the message queue (“msg_q”) is not empty (i.e., follows the “NO” pathway), then the system relays the data accordingly to the controls, actuators, and the status/error query. Downstream functions then provide data input to a plurality of solenoids, valves, DEP amplifiers (“amps”), UART text (“TX”), and LEDs.

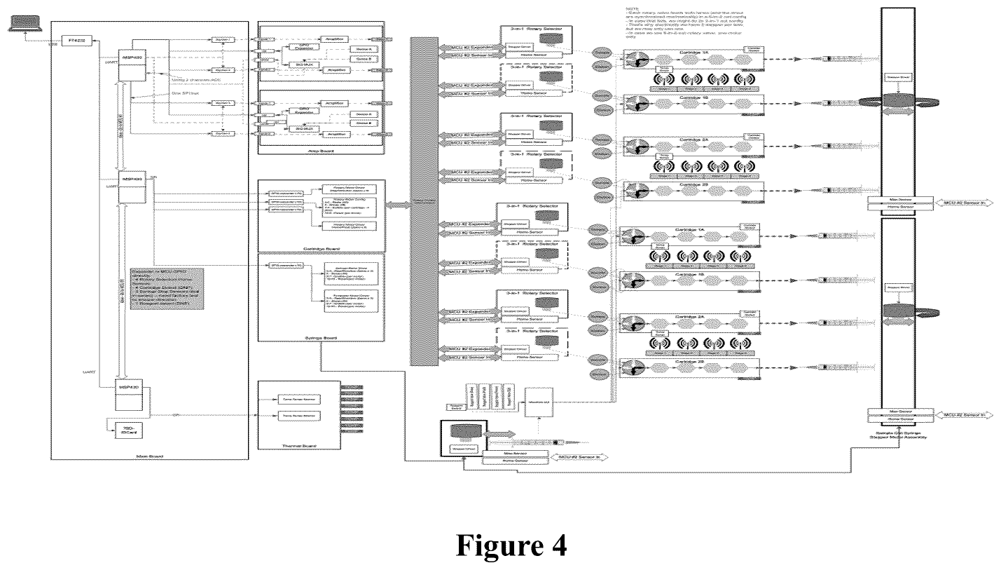

FIG. 4 illustrates an example program flow diagram for operating one or more rotary valves of a cartridge. In accordance with the preferred embodiment of the present invention, cartridge 102 may be contained within one or more apparatus. As an example, and not by way of limitation, cartridge 102 may be contained within apparatus ExoPrep. The ExoPrep device may be controlled by a suite of software including a higher-level software (“SW”) consisting of a Graphical User Interface (“GUI”) and an Application Programming Interface (“API”) Server backend that runs on a computer; and a lower-level firmware (“FW”) that runs on a set of microprocessor working cooperatively.

The objective of the FW is to control and monitor the various actuators and sensors present in the ExoPrep system to perform assays on biological samples. The FW and the SW communicate using a set of proprietary communications protocol. There are two different protocols: the main communication protocol and the Bootloader protocol. The FW is divided into two operational modes: Normal/Kernel mode and Bootloader mode. The Bootloader mode is entered via a special sequence of commands to protect from accidental entry. The purpose of the Bootloader mode is to support device reprogramming without the use of vendor-specific circuit design or protocols to prevent vendor-lock-in and ensure control of the manufacturing and build process. The Bootloader mode contains only the essential commands to allow third-party manufacturers to use without exposing FW details that might pertain to algorithms and methods or any product-specific knowledge. In this way the Bootloader is generic and agnostic and can be re-used on any of the same microprocessors. The Bootloader mode is responsible for loading the particular kernel program on each microprocessor. The Bootloader operates agnostic of the kernel content but does perform an integrity check prior to transferring control of the microprocessor to the kernel. The main operating mode, the Kernel Mode, in the FW, is the main program that operates each microprocessor. It contains the programs that are used to accomplish each microprocessors' objectives.

The ExoPrep FW is delivered as a bundle that contains several software binary images each containing a Bootloader and a Kernel program. Each image that can be programmed into a microprocessor is recorded in a manifest file that contains a CRC-16 checksum that is verified post programming and during boot to ensure integrity. The Bootloader will not allow transfer of control if the event that the integrity check fails.

The main kernel programs for the ExoPrep include an FW program image for one of the microprocessors in the ExoPrep device that is used to manipulate the fluidic control systems such as the motors, pumps, valves, and other proprietary composite fluidic devices (such as cartridges and manifolds). The same microprocessor FW also includes functions to monitor various sensors onboard the ExoPrep device. One of the FW program images for one of the microprocessors in the ExoPrep device is used to control and manipulate the DEP fields generated using various waveform signal generation and amplification electronics. This FW also includes functions to monitor current and power consumption to ensure integrity of the biological sample during method execution. One of the program images for one of the microprocessors in the ExoPrep device is used to monitor overall system operating conditions such as over-temperature and faults. This is to be used to perform any corrective actions to prevent malfunction or sample correction, and in event of fault, inform a user of the errors.

Each of the microprocessor main kernel programs also uses a set of shared common libraries developed to ensure commonalities between each of the kernel programs. This set of libraries includes a common set of operating framework, helper functions to manipulate strings and/or characters, and device and peripheral controls. The ExoPrep FW also consists of a series of software to perform the build and bundling tasks. These software are also included as part of the software repository (Mono Repo) that is used to operate the final FW upgrade image bundle. For example, and not by way of limitation this set of build system may utilize CMake and Python to perform the build. The ExoPrep FW also consists of a series of software unit test code that lives in the same hardware. For example, and not by way of limitation, these tests may be developed to utilize the GoogleTest and GoogleMock unit testing framework or other industry standard test and mock unit testing framework.

The microprocessors communicate with each other internally (of the ExoPrep product) via an internal communications bus using proprietary inter-device communications protocol. For example, and not by way of limitation, the ExoPrep FW may be developed and built using C++(C++20) programming language or other industry standard programming languages with the GNU's Compiler Collective (“GCC”) provided by a vendor. The ExoPrep FW may include a few back-ported C++23 headers to assist in memory-safe data structures and algorithm usage.

The ExoPrep API server may be a back ended REST engine that listens to REST messages on HTTP and WebSocket. The commands may be specified using industry standard OpenAPI Specification v3 (“OASv3”). The API server translates the REST messages into low-level FW communication protocol messages and sends them to the ExoPrep device. The use of a front ended backend decoupling for this software architecture allows an ability to decouple the graphical representation from the functional parts of the desktop user program, which allows more rapid changes should the need arise. The API server backend software may be developed in Python programming language and may be complied and installed as a Windows service and executed in the background in Windows.

The ExoPrep GUI is a wizard-based program that is intended for end-user to use to operate the ExoPrep device. The GUI provides the user the ability to manage and execute various methods that is used to perform an assay on a set of given biological samples. The GUI may provide a user with remote computerized control of the system. The GUI may be developed in the Dart programming language using the Flutter graphical user interface toolkit to allow expansions to any platforms (Windows, IOS, Android, Linux, MacOS, etc.) in a modern user interface paradigm.

The ExoPrep device electrical hardware is designed to operate the various pumps, servos, valves, safety interlocks, sensors, and indicators required to prepare and process the supplied sample. The electrical portion of the device is loosely divided into functional areas including commination and control performed by three microcontrollers running the FW described above, fluidic manipulation performed via a set of pumps, resistance and mechanically driven valves controlled by optical and mechanical sensors, sample processing performed within the fluidic IC by application and voltage and frequency defined electrical signals developed to perform DEP according to predetermined process parameters, and power generation and applicable safety interlocks handled with electronic and mechanical controls.

The microcontrollers communicate with an external computer via USB and internally with a combination of SPI and I2C as well as direct GPIO manipulation. The microcontrollers provide the timing and sequencing for stepper drivers operating multi-position fluid routing, linear and peristaltic pumps, resistance-based valves, and a reagent cartridge loading system. The microcontrollers provide signal generation from <1 Hz to 25 MHz for the purpose of generating up to four sine waves at controllable frequencies and voltage swings. The microcontrollers provide phase control across all signals. The microcontrollers measure and report the current consumed on a cycle to cycle and aggregate basis of the generated signal as it is passed through the IC. The microcontrollers are capable of real-time signal adaptation based on the readings obtained. The microcontrollers monitor temperature at various points across the entire system and control fans and power inputs to maintain the desired thermal envelope for the sample and the supporting electronics. Power is supplied to the system via a 24V external “brick style” power supply and further processed inside the system to the voltages required to support all the mechanical and signal driven dissipation. The power system is also filtered at inputs to mitigate EMI in either direction. In concert with the FW electrical system is able to complete the entire cycle of loading, prepping, and processing a sample with minimal interaction from the user.

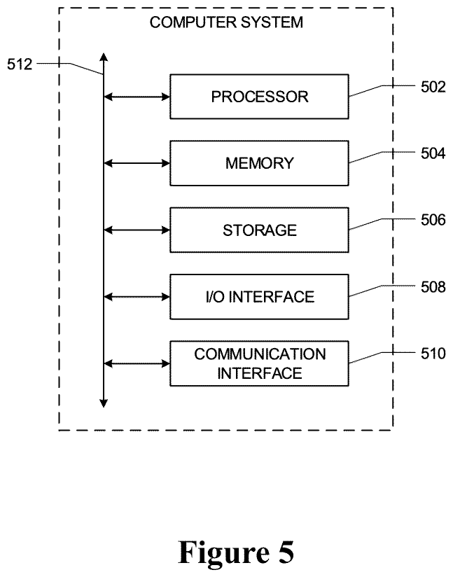

FIG. 5 illustrates an example computer system 500 that may be utilized to perform digital, multiplexed, extracellular vesicle-derived biomarker lab-on-a-chip diagnostics, in accordance with the presently disclosed embodiments. In accordance with the preferred embodiment of the present invention, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates a computer system 500 taking any suitable physical form. As example and not by way of limitation, computer system 500 may be an embedded computer system, a system-on-chip (“SOC”), a single-board computer system (“SBC”) (for example, a computer-on-module (“COM”) or system-on-module (“SOM”), a desktop computer system, a laptop or notebook computer system, an interactive kiosk, a mainframe, a mesh of computer systems, a mobile telephone, a personal digital assistant (“PDA”), a server, a tablet computer system, an augmented or virtual reality device, or a combination of two or more of these. Where appropriate, computer system 500 may include one or more computer systems 500; be unitary or distributed; span multiple locations; span multiple machines; span multiple date centers; or reside in a cloud, which may include one more or more cloud components in one or more networks.

Where appropriate, one or more computer systems 500 may perform, without substantial spatial or temporal limitation, one or more steps of one or more methods described or illustrated herein. As an example, and not by way of limitation, one or more computer systems 500 may perform, in real-time or in batch mode, one mor more steps of one or more methods described or illustrated herein. One or more computer systems 500 may perform, at different time or at different locations, one or more steps of one or more methods described or illustrated herein, where appropriate.

In particular embodiments, computer system 500 includes a processor 502, memory 504, storage 506, an input/output (“I/O”) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement. In particular embodiments, processor 502 includes hardware for executing computer-readable instructions, such as those making up a computer program. As an example, and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example, and not by way of limitation, processor 502 may include one or more instruction caches, one or more data caches, and one or more translation lookaside buffers (“TLBs”). Instructions in the instruction caches may be copies of instructions in memory 504 or storage 506, and the instruction caches may speed up retrieval of those instructions by processor 502.

Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translations for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (“ALUs”); be a multicore processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example, and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere).

In particular embodiments, storage 506 includes mass storage for data or instructions. As an example, and not by way of limitation, storage 506 may include a hard disk drive (HDD), a floppy disk drive, flash memory, an optical disc, a magneto-optical disc, a magnetic tape, or a universal serial bus (“USB”) drive or a combination of two or more of these. Storage 506 may be internal or external to computer system 500, where appropriate. In particular embodiments, storage 506 is non-volatile, solid-state memory. In particular embodiments, storage 506 includes read-only memory (“ROM”). Where appropriate, this ROM may be mask-programmed ROM, programmable ROM (“PROM”), erasable PROM (“EPROM”), electrically erasable PROM (“EEPROM”), electrically alterable ROM (“EAROM”), or flash memory or a combination of two or more of these. This disclosure contemplates mass storage 506 taking any suitable physical form. Storage 506 may include one or more storage protocol units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example, and not by way of limitation, an I/O device may include a keyboard, a keypad, a microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interfaces 508 may include one or more I/O interfaces 510, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example, and not by way of limitation, communication interface 510 may include a network interface controller (“NIC”) or network adapter for communicating with an Ethernet or other wire-based network or a wireless NIC (“WNIC”) or wireless adapter for communicating with a wireless network, such as a WI-FI network. This disclosure contemplates any suitable network and any suitable communication interface 510 for it.

As an example, and not by way of limitation, computer system 500 may communicate with an ad hoc network, a personal area network (“PAN”), a local area network (“LAN”), a wide area network (“WAN”), a metropolitan area network (“MAN”) or one or more portions of the Internet or a combination of two or more of these. One or more portions of one or more of these networks may be wired or wireless. As an example, and not by way of limitation, computer system 500 may communicate with a wireless PAN (“WPAN”) (such as, for example, a Bluetooth WPAN), a WI-FI network, a WI-MAX network, a cellular telephone network (such as, for example a Global System for Mobile Communications (“GSM”) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (“AGP”) or other graphics bus, an Enhanced Industry Standard Architecture (“EISA”) bus, a front-side bus (“FSB”), a hypertransport (“HT”) interconnect, an Industry Standard Architecture (“ISA”) bus, an InfiniBand interconnect, a low-pin-count (“LPC”) bus, a memory bus, a Micro Channel Architecture (“MCA”) bus, a Peripheral Component Interconnect (“PCI”) bus, a PCI-Express (“PICe”) bus, a serial advanced technology attachment (“SATA”) bus, a Video Electronics Standards Association Local (“VLB”) bus, or another suitable bus or a combination or two or more of these. Bus 512 may include one or more buses 512, where appropriate. Although this disclosure describes and illustrates a particular bus, this disclosure contemplates any suitable bus or interconnect.

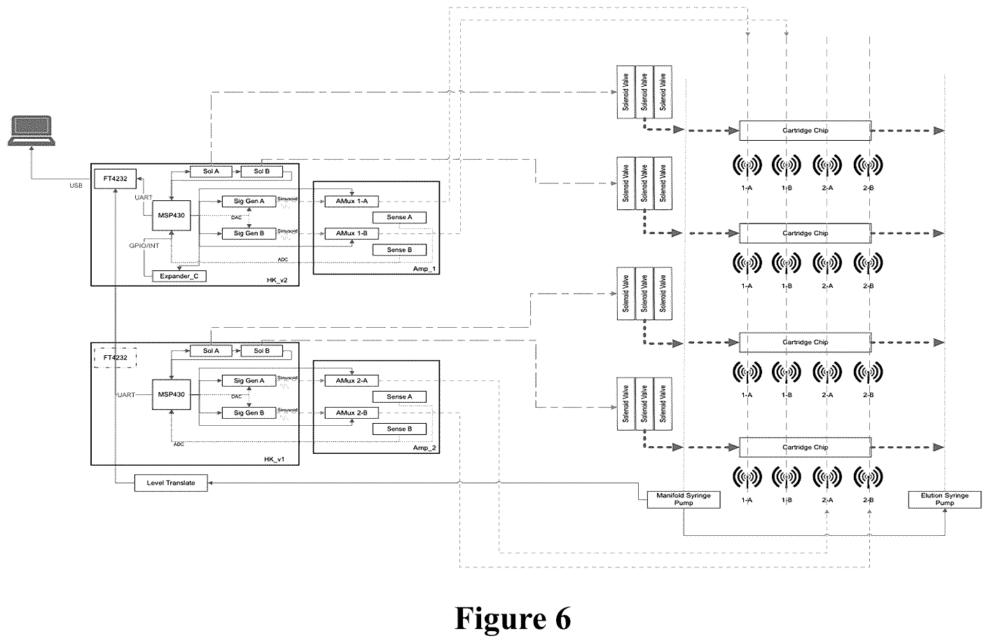

FIG. 6 illustrates an example hybrid program flow diagram. In accordance with the preferred embodiment of the present invention, instructions are streamlined from a microcontroller MSP430 to signal generators A and B, which provide input to respective analog multiplexers AMux 1-A and 1-B, and 2-A and 2-B. The analog multiplexors may provide sinusoid signals to a plurality of cartridges. Microcontroller MSP430 additionally communicates with a plurality of solenoid valves via Sol A and Sol B as shown. The plurality of solenoid valves interacts with cartridges as well as a manifold syringe pump and elution syringe pump. The manifold syringe pump is also in communication with the level translate which communicates with the bus (as further illustrated and described in FIG. 4) and the computer system (as further illustrated and described in FIG. 4 and FIG. 5). The components shown in FIG. 6 are by way of example and not by way of limitations. Other suitable program flows are contemplated in the present invention.

As illustrated in FIG. 4, FIG. 6 illustrates the main kernel programs for the ExoPrep include an FW program image for one of the microprocessors in the ExoPrep device that is used to manipulate the fluidic control systems such as the motors, pumps, valves, and other proprietary composite fluidic devices (such as cartridges and manifolds). The same microprocessor FW also includes functions to monitor various sensors onboard the ExoPrep device. One of the FW program images for one of the microprocessors in the ExoPrep device is used to control and manipulate the DEP fields generated using various waveform signal generation and amplification electronics. This FW also includes functions to monitor current and power consumption to ensure integrity of the biological sample during method execution. One of the program images for one of the microprocessors in the ExoPrep device is used to monitor overall system operating conditions such as over-temperature and faults. This is to be used to perform any corrective actions to prevent malfunction or sample correction, and in event of fault, inform a user of the errors.

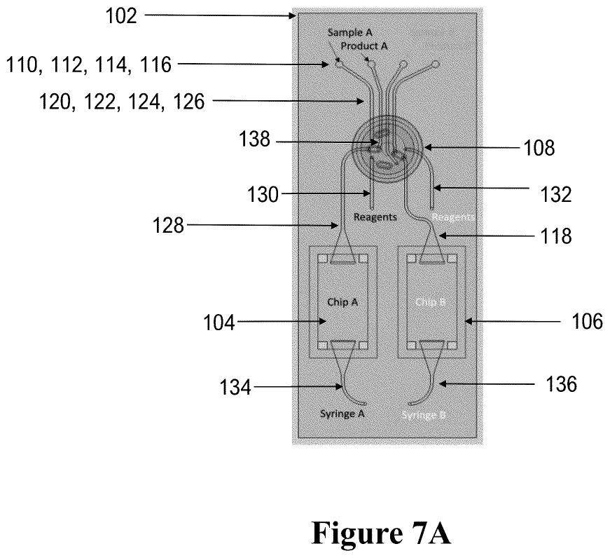

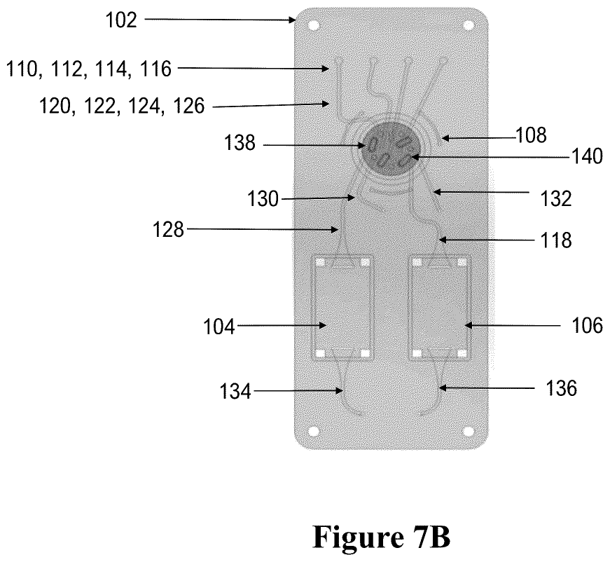

FIGS. 7A-B illustrate diagrams 700, 730, of a top-view of a cartridge 102 concept. In accordance with the preferred embodiment of the present invention, Sample A may be input via part 110, wherein the first biological sample may be input to part 110 of cartridge 102 via fluidics machinery, medical equipment (for example, and not by way of limitation, a syringe), and/or one or more mechanisms for accepting biological sample inputs. Although this disclosure discussed the aforementioned methods of inputting a biological sample into one or more DEP chambers of the filter system, this disclosure contemplates any suitable method of delivering one or more biological samples into cartridge 102. In some embodiments, chip 104 may receive Sample A for processing via fluidics channel 128. In particular embodiments, part 112 of cartridge 102 may output Product A.

In particular embodiments, Sample B may be input via part 114, wherein the first biological sample may be input to part 114 of cartridge 102 via fluidics machinery, medical equipment (for example, and not by way of limitation, a syringe), and/or one or more mechanisms for accepting biological sample inputs. Although this disclosure discussed the aforementioned methods of inputting a biological sample into one or more DEP chambers of the filter system, this disclosure contemplates any suitable method of delivering one or more biological samples into cartridge 102. In some embodiments, chip 106 may receive Sample B for processing via fluidics channel 118. In particular embodiments, part 116 of cartridge 102 may output Product B.

In particular embodiments, fluidics channels 120, 122, 124, 126 may carry one or more biological samples through the cartridge 102 to one or more chips 104, 106. As an example, and not by way of limitation, fluidics channels 120, 122, 124, 126 may move fluid (for example, biological samples, wash volume, etc.) between one or more components of cartridge 102. In particular embodiments, fluidics channels 120, 122, 124, 126 may operate as an immediate storage and/or waste system. As an example, and not by way of limitation, fluidics channels 120, 122, 124, 126 may be coated by one or more films, sealing the back of one or more injection molded parts of cartridge 102. As an example, and not by way of limitation, fluidics channels 120 and 124 may be the same length. As an example, and not by way of limitation, fluidics channels 122 and 126 may be the same length.

In particular embodiments, rotary valve 138 may be comprised of two or more pieces. As an example, and not by way of limitation, rotary valve 138 may be injection molded with an over molding of thermoplastic elastomers (“TPE”). In particular embodiments, rotary valve may be held in place by one or more acrylic pieces 108.

In particular embodiments, reagent-in fluidic line 130 may input reagent for Sample A. In particular embodiments, reagent-in fluidic line 132 may input reagent for Sample B. In particular embodiments, Product A may be output via waste fluidic 134. In particular embodiments, Product B may be output via waste fluidic 136.

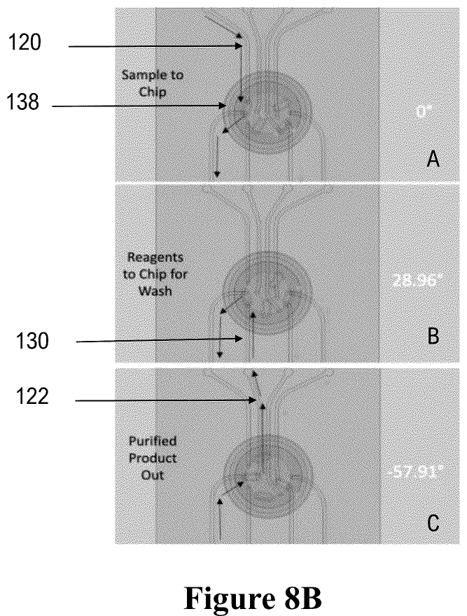

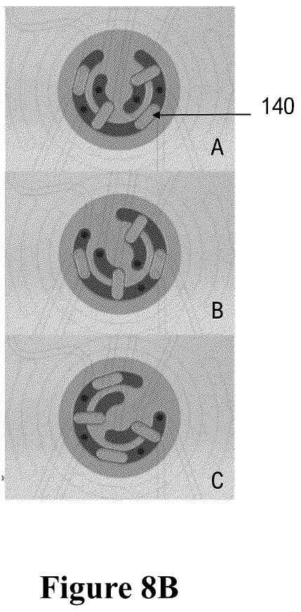

FIGS. 8A-B illustrate example diagrams of a rotary valve 138 in particular configurations. In accordance with the preferred embodiment of the present invention, a sample which has been inserted into the chip enters the rotary valve 138 via a fluidics channel 120 at a position of 0 degrees in Panel A of FIG. 8A. Fluidic movement of the sample, the reagent, and the purified product is represented by arrows in Panels A, B, and C, of FIG. 8A, respectively. Reagents are inserted into the rotary valve 138 via a reagent-in fluidic line 130 at position in the range of 25-35 degrees. For example, and not by way of limitation, the position may be at 28.96 degrees as shown in Panel B of FIG. 8A. A purified product exits the rotary valve 138 via fluidics channel 122 at a position in the range of −55 to −65 degrees. For example, and not by way of limitation the position may be −57.91 degrees as shown in Panel C of FIG. 8A. FIG. 8B illustrates the arrangement of the rotary valve 138 in the positions of 0 degrees (Panel A), 28.96 degrees (Panel B), and −57.91 degrees (Panel C).

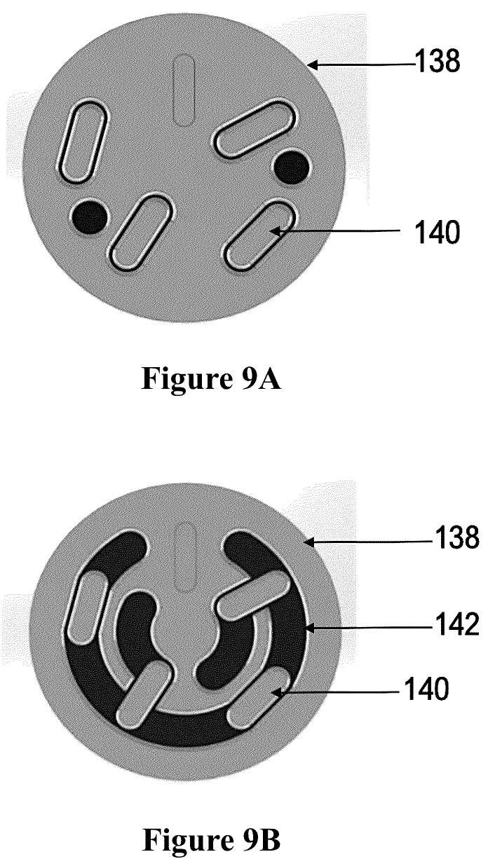

FIGS. 9A-B illustrate example diagrams of rotary a rotary valve 138 in particular configurations. In accordance with the preferred embodiment of the present invention, FIG. 9A shows the inlet/outlet ports 140 of the rotary valve 138. FIG. 9B shows rotary valve 138 with the plurality of inlet/outlet ports 140 as shown in FIG. 9A encompassed within the rotor 142 of the rotary valve 138.

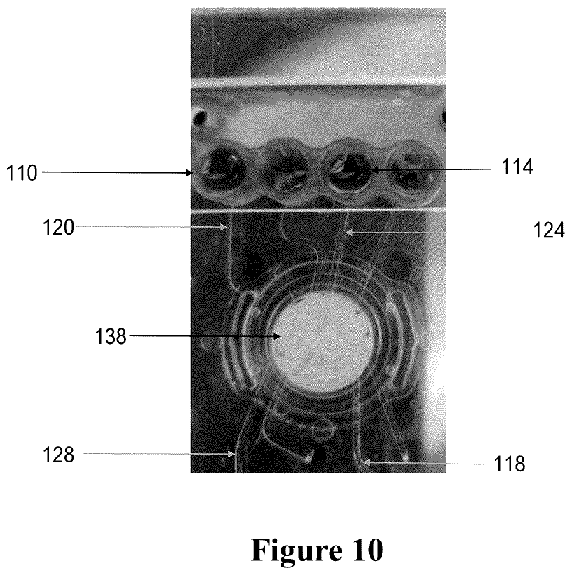

FIG. 10 illustrates an example diagram of a cartridge 102, containing one or more fluidics channels and parts. FIG. 10 specifically illustrates wherein samples have been loaded into parts 110 and 114 but have not yet entered the rotary valve 138. In accordance with the preferred embodiment of the present invention, part 110 delivers a sample to the rotary valve 138 via fluidics channel 120 and exits the rotary valve 138 via fluidics channel 128. Similarly, part 114 delivers a sample to the rotary valve 138 via fluidics channel 124 and exits the rotary valve via fluidics channel 118. See FIG. 1 for further details regarding the movement of samples across the rotary valve 138.

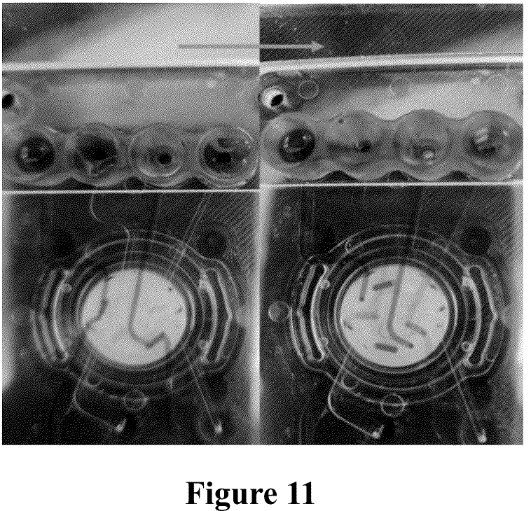

FIG. 11 illustrates example diagrams of a cartridge, containing one or more fluidics channels 120, 122, 124, 126 and parts 110, 112, 114, 116. In accordance with the preferred embodiment of the present invention, a cartridge 102 allows fluid samples to travel from parts 110, 112, 114, 116 to a rotary valve 138 via fluidics channels 120, 122, 124, 126. As the fluid sample or samples moves through the rotary valve 138, they are passed to respective fluidics channels 118, 128 to be dispersed onto chip 106 and 104, respectively. A reagent fluid may also be moved through the rotary valve 138 via reagent-in fluidic lines 130, 132. Panels A and B of FIG. 11 show separate moments in time as the fluids move across the rotary valve 138, with the configuration of Panel B occurring at a later time than the configuration in Panel A.

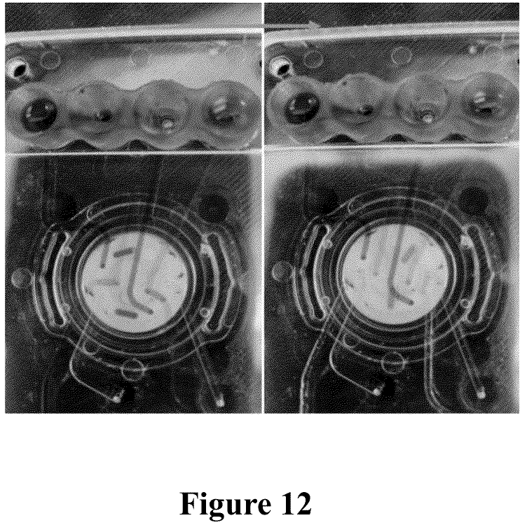

FIG. 12 illustrates example diagrams of a cartridge 102, containing one or more fluidics channels 120, 122, 124, 126 and parts 110, 112, 114, 116. In accordance with the preferred embodiment of the present invention, a cartridge 102 allows fluid samples to travel from parts 110, 112, 114, 116 to a rotary valve 138 via fluidics channels 120, 122, 124, 126. As the fluid sample or samples moves through the rotary valve 138, they are passed to respective fluidics channels 118, 128 to be dispersed onto chip 106 and 104, respectively. A reagent fluid may also be moved through the rotary valve 138 via reagent-in fluidic lines 130, 132. Panels A and B of FIG. 12 show separate moments in time as the fluids move across the rotary valve 138, with the configuration of Panel B occurring at a later time than the configuration in Panel A.

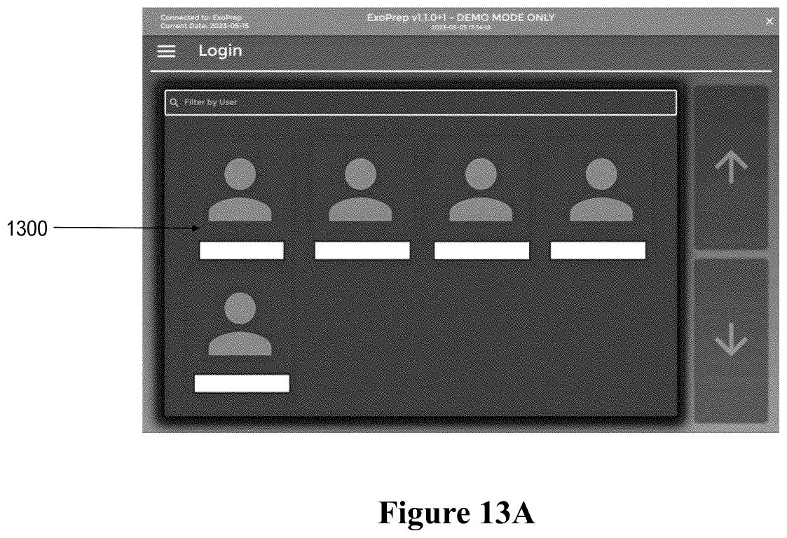

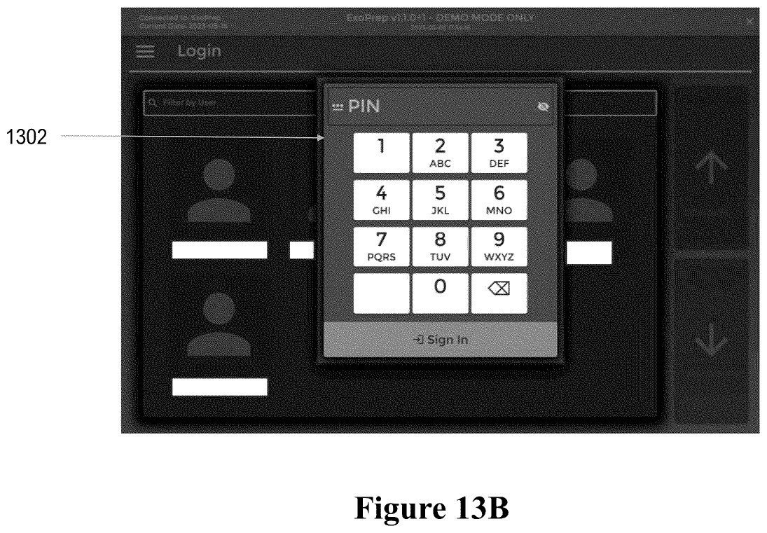

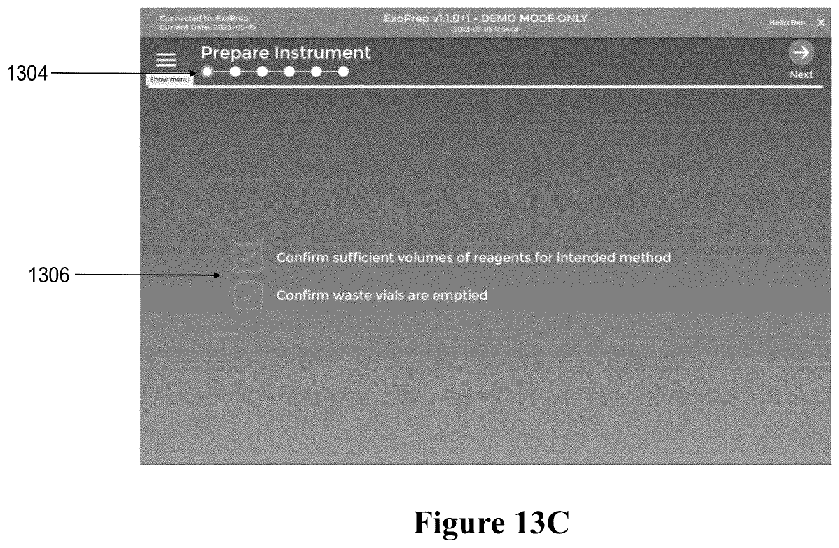

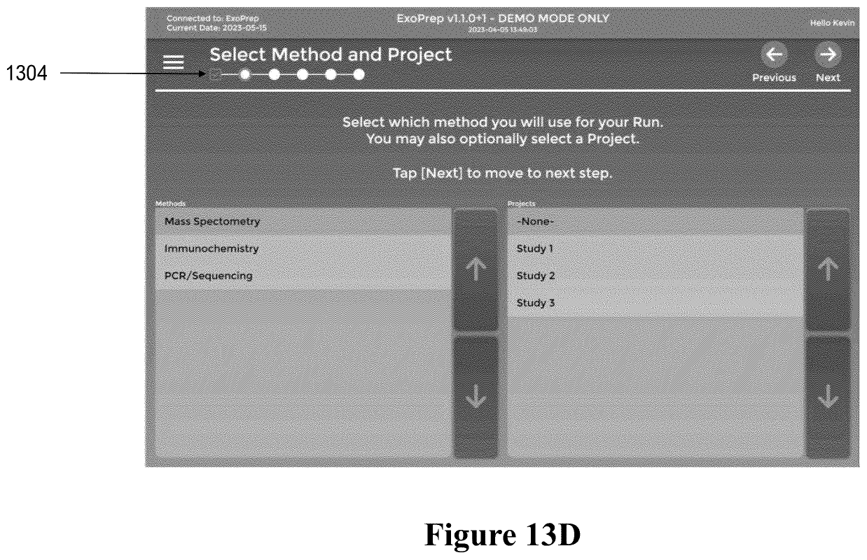

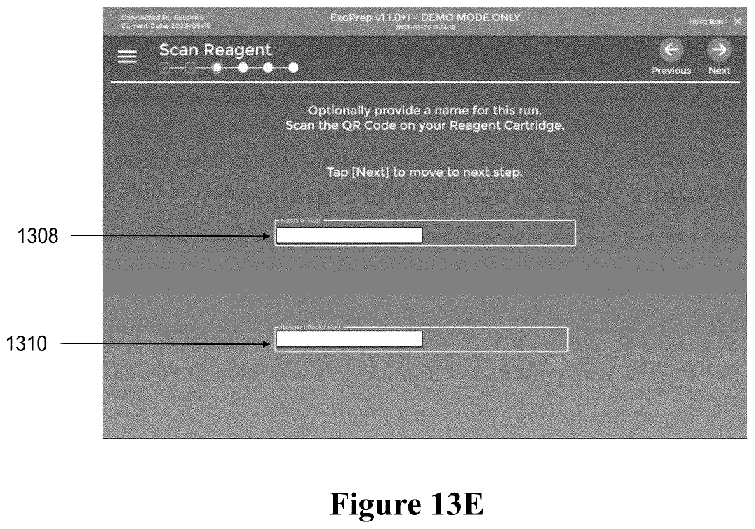

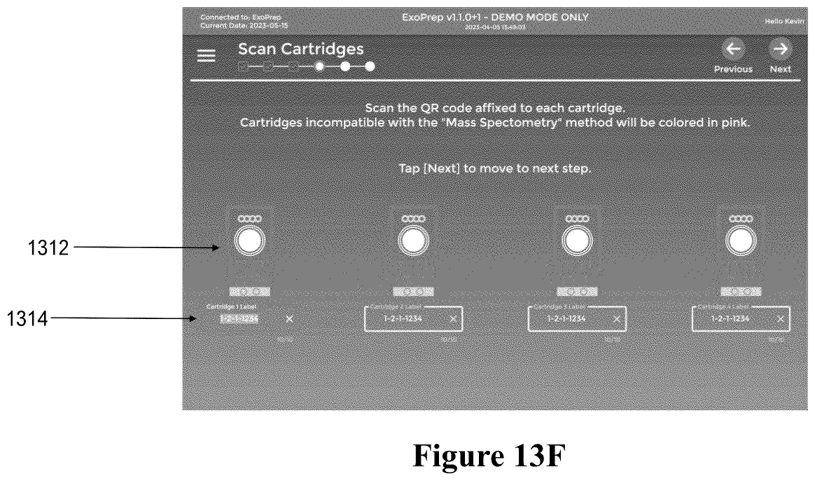

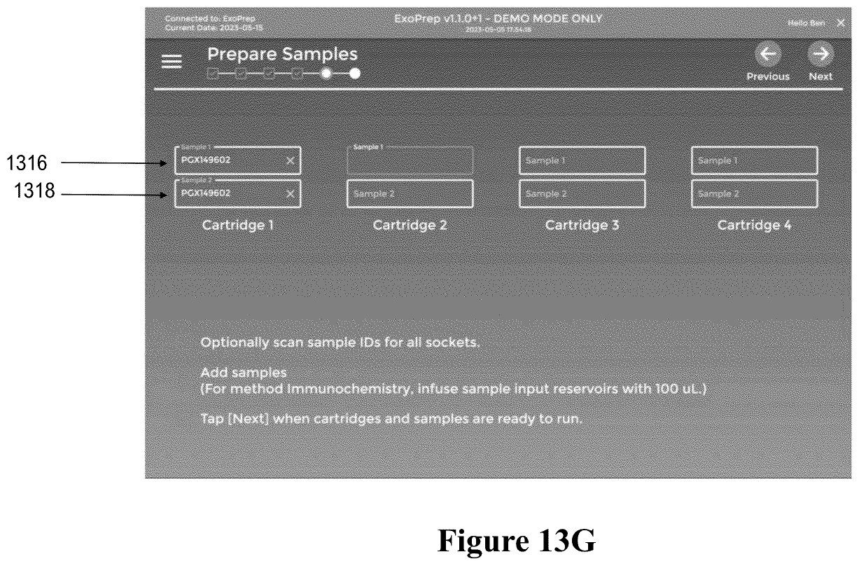

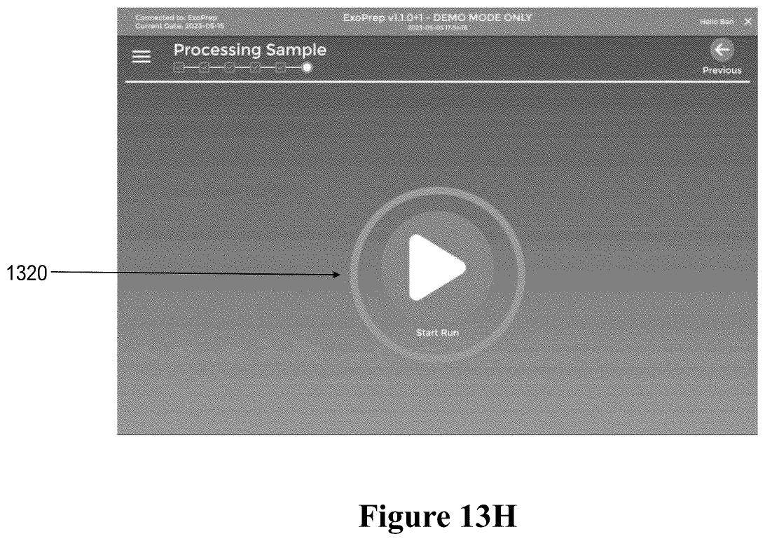

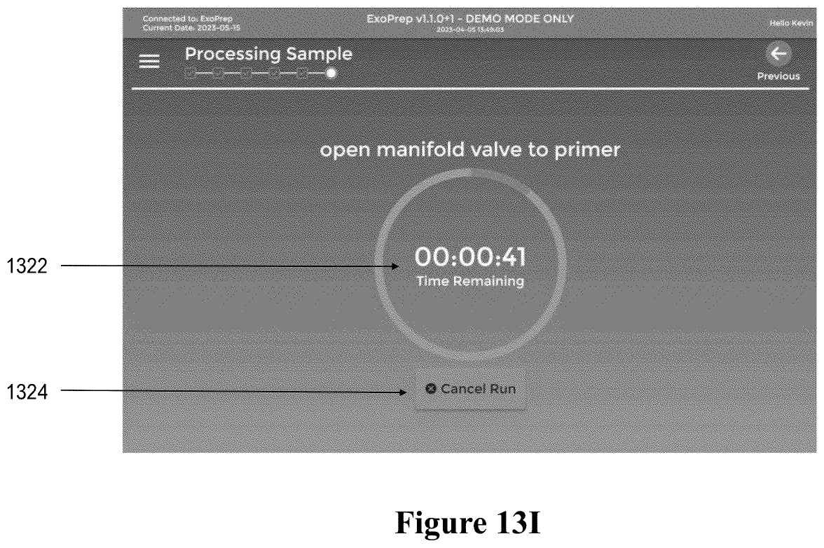

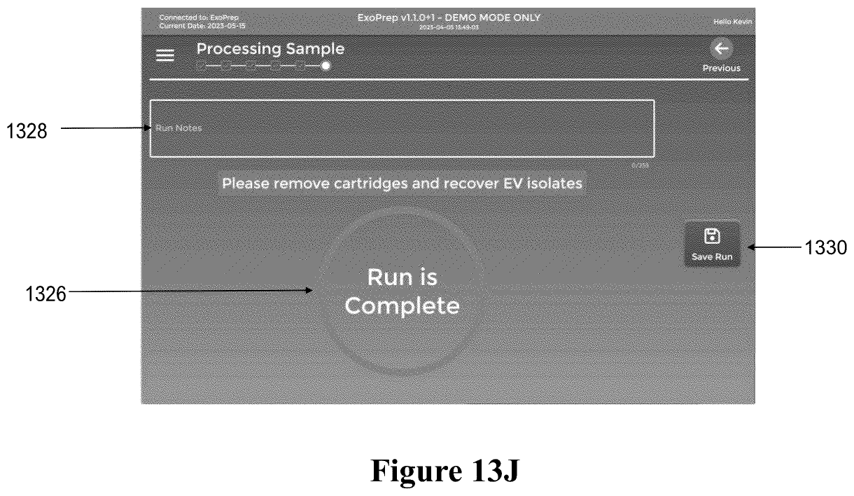

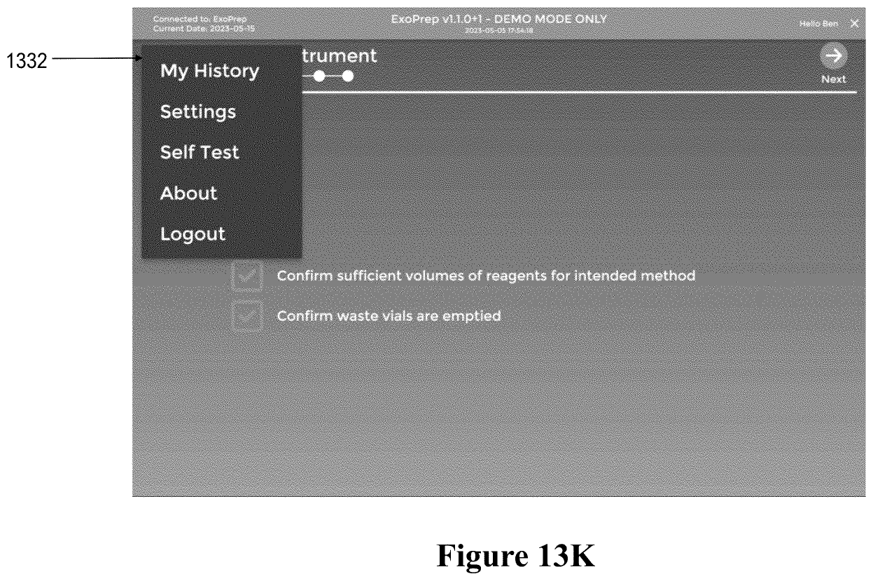

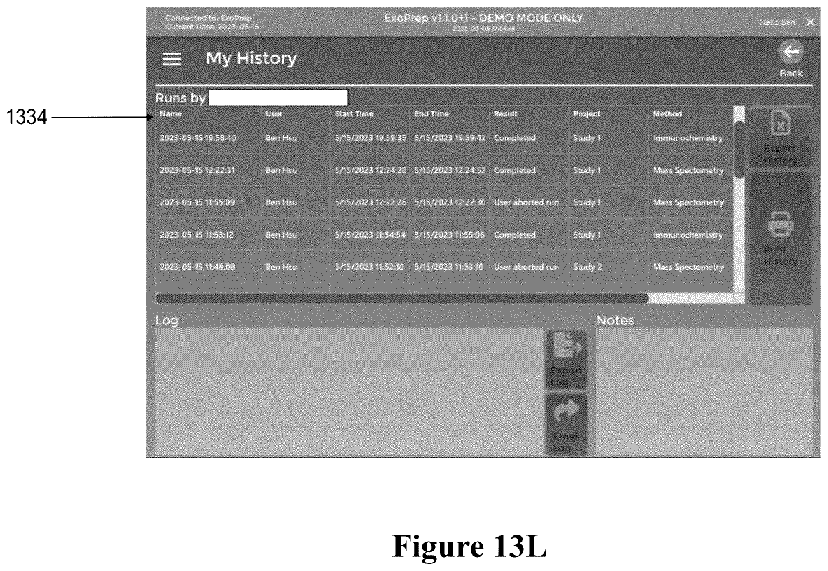

FIGS. 13A-L illustrate various screens of a virtual portal. In accordance with the preferred embodiment of the present invention, FIG. 13A shows an exemplary first login screen wherein a user may click, touch, or otherwise indicate a selection of a user icon 1300 to enter the profile of the user associated with the selected user icon. As illustrated in FIG. 13B, in some embodiments, a second window 1302 may populate the screen with the requirement to enter a PIN in order to begin the protocol with the selected user. The PIN may be a multi-digit code unique to the selected user icon populated on the first login screen. Once the correct PIN is entered, the user is directed to begin the protocol. As illustrated in FIG. 13C, the protocol may begin on a first screen where a progress bar 1304 may be indicated in the upper left corner of the screen and the title for each step may be found. For example, and not by way of limitation, the step illustrated in FIG. 13B is “Prepare Instrument.” In some embodiments the first step may provide at least one checkbox 1306 on the first screen once the protocol has begun. For example, and not by way of limitation, these checkboxes 1306 may guide the user through the initial steps of the protocol. Exemplary steps which may be presented with checkboxes 1306 include but are not limited to “confirm sufficient volumes of reagents for intended method” and “confirm waste vials are emptied” as illustrated in FIG. 13C. Clicking, touching or otherwise checking the boxes may be optional or required in order to proceed to the following step of the protocol. This may be adjusted in a settings menu.

The next step is illustrated in FIG. 13D. In this step (indicated as the second step in the progress bar 1304), a user may be asked to indicate methods used and project number. Exemplary methods include mass spectrometry, immunochemistry, and PCR/sequencing. Other suitable methods may be used and may be offered for selection on this screen. Project selection allows a user to separately maintain several studies and ensure data collected is associated with the correct project. Once a method and project are selected, the user is brought to a third screen (illustrated in FIG. 13E) on which they are prompted to optionally name the run in textbox 1308 and scan a QR code located on the user's reagent cartridge. Scanning of the QR code redirects the associated information from the reagent cartridge to the computer and populates the associated code into textbox 1310. This step syncs the data collected from the reagent cartridge with the project and run specified. In some embodiments, the reagent identification includes an expiration date to ensure methods are valid. The reagent pack QR code may be affixed to the reagent holder. A barcode or QR code may be used for the mass spectroscopy reagent pack. On the following screen, the user is prompted to scan each cartridge QR code and insert the cartridge, one by one, into the instrument. Each cartridge has a unique QR code label affixed to it, however FIG. 13F illustrates a single exemplary code for each of four cartridges for demonstration purposes. If an issue arises from scanning a QR code, the codes may alternatively be entered manually.

FIG. 13G illustrates the following screen, on which a user has the option to enter information about each of samples 1 and sample 2 in the text boxes 1316 and 1318 associated with each cartridge, respectively. This information may be adjusted to be required in order to proceed to the following step. In some embodiments, the samples are identified via a bar code or QR code which may be scanned to redirect sample identification information to the computer. Alternatively, this information may be inputted manually. On the final screen presented (illustrated in FIG. 13H), the user is asked to physically confirm, via clicking, touching, or otherwise selecting a start button 1320 to communicate to the instrument to begin the selected method of processing. Once the user starts the process, a countdown timer 1322 may populate the screen as illustrated in FIG. 13I. As the countdown runs, the user is presented with the option to cancel the run 1324, which, upon selection, will stop all activities, close all valves, and return to a safe position for cartridge removal. Once the user confirms removal, a new run may begin. The process may not be paused and restarted as this would invalidate the method.

A notification will be sent to the email associated with the account of the user indicated on the first screen once the run is complete. In alternative embodiments, this notification may be provided via text message, push notification, or other methods or a combination of at least two of these. The screen may also populate with a message that the run is complete 1326 and an instruction for the user to remove the cartridges and recover EV isolates as illustrated in FIG. 13J. At this point, the user may enter any information including metadata regarding the run in the Run Notes 1328 which will be captures in the built-in database. The user may also export the history or run notes at a later time. Once the run is saved by selecting the “Save Run” box 1330 on the right of the screen, the user is returned to the first screen of the protocol entitled “Prepare Instrument” and another run may be prepared.

From all screens presented, a user may access a drop-down menu 1332 as illustrated in FIG. 13K which provides access to additional program options including settings, history, self-test, about and logout. Under the settings option, projects are maintained and run defaults may be adjusted, locations specified, and software updates made. Under the history option, a user may view a list of previous runs 1334 associated with the account of the selected profile as illustrated in FIG. 13L. To see a list of all runs for all users, the history page may be accessed prior to logging in to a specific user profile.

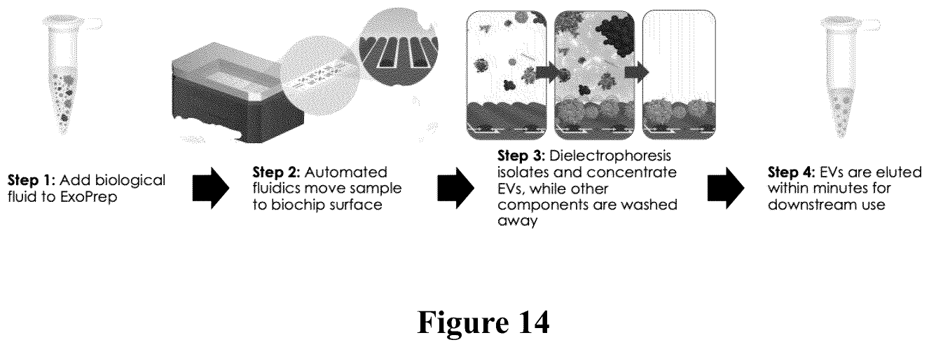

FIG. 14 illustrates a summary of the process steps. In accordance with the preferred embodiment of the present invention, the first step is to add a biological sample fluid to the ExoPrep device. This fluid may be saliva, blood, plasma, urine, or other fluid or fluid-like biological material. The second step involves automated fluidics which move the sample to the surface of the biochip. In the following step, DEP isolates and concentrates EVs, while other compounds are washed away. The final step is to collect the eluted EVs which may be used in further processes.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A system for processing a fluid, said system comprising:
a software suite located on a first computer, said software suite comprising a graphical user interface and an application programming interface, wherein said graphical user interface is configured to allow remote computerized control of a first device;
a plurality of microprocessors configured to control a plurality of sensors located on said first device in communication with said first computer, wherein said first device is configured to receive at least one cartridge unit and wherein said at least one cartridge unit is configured to receive at least one fluid; and
a processor configured to retrieve computer-readable instructions from a memory, wherein said computer-readable instructions, when executed by said processor, cause said system to:
activate said first device via said plurality of microprocessors;
control said first device via at least one microcontroller;
monitor said first device via said plurality of microprocessors; and
communicate, from said first device to said first computer, data regarding said at least one cartridge unit inserted into said first device.

2. The system of claim 1, wherein said at least one cartridge unit comprises at least one receptacle, at least one fluidics channel, at least one rotary valve, and at least one chip configured to process at least one fluid.

3. The system of claim 1, wherein a power consumption and a temperature of said system are monitored by said plurality of microprocessors.

4. The system of claim 1, wherein said at least one microcontroller is further configured to provide timing and sequencing for a plurality of stepper drivers, operate multi-position fluid routing, linear and peristaltic pumps, resistance-based valves and a reagent cartridge loading system.

5. The system of claim 1, wherein said at least one microcontroller controls at least one fan and power input to maintain a desired temperature for said fluid and said first device.

6. The system of claim 1, wherein said fluid is a biological fluid containing at least one biomarker comprising extracellular vesicles.

7. The system of claim 6, wherein said biomarkers are separated from said biological fluid via dielectrophoresis.

8. A method for obtaining a diagnosis from a plurality of biomarkers, said method comprising:
inserting at least one fluid into a cartridge unit;
inserting at least one reagent into said cartridge unit;
inserting said cartridge unit into a first device configured to receive at least one cartridge unit;
retrieving from a memory, via a first processor in communication with said first device and a first computer, computer-readable instructions; and
executing, via said first processor, said computer-readable instructions, causing a plurality of microprocessors associated with said first device to:
activate said first device via said plurality of microprocessors;
control said first device via at least one microcontroller;
monitor said first device via said plurality of microprocessors;
communicate, from said first device to said first computer, data regarding said at least one cartridge unit inserted into said first device; and
present, via a graphical user interface associated with said first computer, a first screen configured to receive user input and confirmation regarding a state of said first device.

9. The method of claim 8, wherein said at least one cartridge unit comprises at least one receptacle, at least one fluidics channel, at least one rotary valve, and at least one chip configured to process at least one fluid.

10. The method of claim 8, wherein a power consumption and a temperature of said first device are monitored by said plurality of microprocessors.

11. The method of claim 8, wherein said at least one microcontroller is further configured to provide timing and sequencing for a plurality of stepper drivers, operate multi-position fluid routing, linear and peristaltic pumps, resistance-based valves and a reagent cartridge loading system.

12. The method of claim 8, wherein said at least one microcontroller controls at least one fan and power input to maintain a desired temperature for said fluid and said first device.

13. The method of claim 8, wherein said fluid is a biological fluid containing at least one biomarker comprising extracellular vesicles.

14. The method of claim 13, wherein said biomarkers are separated from said biological fluid via dielectrophoresis.

15. A system for obtaining a diagnosis from a plurality of extracellular-derived biomarkers, said system comprising:
a software suite located on a first computer, said software suite comprising a graphical user interface and an application programming interface, wherein said graphical user interface is configured to provide a user with remote computerized control of a first device;
a plurality of microprocessors configured to control a plurality of sensors located on said first device in communication with said first computer, wherein said first device is configured to receive at least one cartridge unit and wherein said at least one cartridge unit comprising at least one receptacle, at least one fluidics channel, at least one rotary valve, and at least one chip configured to process at least one fluid, and wherein said at least one cartridge is configured to receive at least one fluid; and
a processor configured to retrieve computer-readable instructions from a memory, wherein said computer-readable instructions, when executed by said processor, cause said system to:
activate said first device via said plurality of microprocessors, wherein activation comprises activating a combination of fluidics channels, rotors, and valves for moving a fluid from a first location to a second location;
control said first device via at least one microcontroller;
monitor said first device via said plurality of microprocessors;
communicate, from said first device to said first computer, data regarding said at least one cartridge unit inserted into said first device; and
present, via said graphical user interface, a first screen configured to receive user input and confirmation regarding a state of said first device.

16. The system of claim 15, wherein a power consumption and a temperature of said system are monitored by said plurality of microprocessors.

17. The system of claim 15, wherein said at least one microcontroller is further configured to provide timing and sequencing for a plurality of stepper drivers, operate multi-position fluid routing, linear and peristaltic pumps, resistance-based valves and a reagent cartridge loading system.

18. The system of claim 15, wherein said at least one microcontroller controls at least one fan and power input to maintain a desired temperature for said fluid and said first device.

19. The system of claim 15, wherein said fluid is a biological fluid containing biomarkers comprising extracellular vesicles.

20. The system of claim 19, wherein said biomarkers are separated from said biological fluid via dielectrophoresis.
